(19) United States
(12) Patent Application Publication
(10) Pub. No.: US 2024/0266849 A1
(43) Pub. Date: Aug. 8, 2024

(54) POWER SUPPLY DEVICE

(71) Applicant: DENSO CORPORATION, Kariya-city (JP)

(72) Inventor: KUNIHIKO MATSUDA, Kariya-city (JP)

(21) Appl. No.: 18/620,694

(22) Filed: Mar. 28, 2024

Related U.S. Application Data
(63) Continuation of application No. PCT/JP22/34763, filed on Sep. 16, 2022.

(30) Foreign Application Priority Data
Oct. 1, 2021 (JP) 2021-162672

(51) Int. Cl. H02J 7/00; H02P 27/06

(52) U.S. Cl. CPC H02J 7/0034; H02J 7/0047; H02J 7/0063; H02J 2207/20; H02P 27/06

(57) ABSTRACT

A reverse connection protection relay of a power supply device is provided in a power supply line between a battery and an input capacitor and is parallel connected with a diode that allows current flow from a battery side to a power converter side, and interrupts the current flow from the power converter side to the battery side when the protection relay is turned off. At a time of initial check, a booster circuit performs an overboost process in which a target voltage is temporarily raised above a value during normal operation. A precharge circuit applies a boosted voltage to an electrode on a high potential side of the input capacitor. A monitoring circuit detects an abnormal due to being stuck in an ON state or in an OFF state of the protection relay according to a post-relay voltage that is a voltage on the inverter side of the protection relay.

### CROSS REFERENCE TO RELATED APPLICATIONS

This application is a continuation application of International Patent Application No. PCT/JP2022/034763 filed on Sep. 16, 2022, which designated the U.S. and based on and claims the benefits of priority of Japanese Patent Application No. 2021-162672 filed on Oct. 1, 2021. The entire disclosure of all of the above applications is incorporated herein by reference.

### TECHNICAL FIELD

The present disclosure relates to a power supply device.

### BACKGROUND

Conventionally, in a power supply device that converts DC power from a battery using a power converter such as an inverter and supplies it to a load such as a three-phase motor, a reverse connection protection relay is provided in a power line between the battery and the power converter.

### SUMMARY

An object of the present disclosure is to provide a power supply device that appropriately performs an initial check of a reverse connection protection relay in a configuration that does not include a power supply relay.

A power supply device of the present disclosure includes a power converter, an input capacitor, a booster circuit, a precharge circuit, and a reverse connection protection relay. The power converter includes one or more sets of switching elements in upper and lower arms connected in series between a power supply line connected to the battery and a ground line, and converts a DC power of the battery and supplies the converted power to a load.

The input capacitor is connected in parallel to a battery on the battery side of the power converter. The booster circuit boosts the input voltage supplied from the battery to a target voltage. The precharge circuit applies the boosted voltage output by the booster circuit to the electrode on the high potential side of the input capacitor and precharges it.

The reverse connection protection relay is provided in a power supply line between the battery and the input capacitor and is parallel connected with a diode that allows current flow from the battery side to the power converter side, and interrupts the current flow from the power converter side to the battery side when the reverse connection protection relay is turned off. The power supply device does not include a power supply relay that interrupts the current flow from the battery side to the power converter side through the power supply line between the battery and the reverse-connection protection relay in an off state.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a circuit diagram of a power supply device according to an embodiment;

FIG. 2 is a block diagram showing a configuration of a monitoring circuit in the power supply device of FIG. 1;

FIG. 3 is a diagram illustrating an initial check flow when a reverse connection protection relay is normal;

FIG. 4 is a diagram illustrating a detection of an abnormal state due to being stuck in the ON state of a reverse connection protection relay; and

FIG. 5 is a diagram illustrating a detection of an abnormal state due to being stuck in the OFF state of a reverse connection protection relay.

### DETAILED DESCRIPTION

In an assumable example, in a power supply device that converts DC power from a battery using a power converter such as an inverter and supplies it to a load such as a three-phase motor, a reverse connection protection relay is provided in a power line between the battery and the power converter. For example, a power relay (a first FET) on the battery side of the power line and a reverse connection protection relay (a second FET) on the inverter side of the power line are connected in series. An electrode on a high potential side of a capacitor is connected between the reverse connection protection relay and the inverter. During an initial check, a control unit detects a failure of the power relay and the reverse connection protection relay based on a voltage at point P1 between the power supply relay and the reverse connection protection relay, and a voltage at point P2 between the reverse connection protection relay and the inverter, when a voltage is charged to the electrode on the high potential side of the capacitor.

Assuming that the power supply relay is normal in the initial check in the example, when the reverse connection protection relay is in an abnormal state due to being stuck in the ON state, the voltage between the relays (at point P1) during the OFF operation becomes the capacitor charge voltage Vc. Further, when the reverse connection protection relay is in an abnormal due to being stuck in the OFF state, the voltage between the relays (at point P1) becomes 0 [V] during the ON operation. In this way, the voltage between the relays is used for abnormality monitoring.

However, there may be a demand for eliminating the power supply relay in order to reduce the number of components. When the power supply relay is not provided, the battery voltage may be applied to an input part of the inverter even during the stop of the system. Therefore, it is possible to stabilize a charging voltage. However, without providing the power supply relay, it is not possible to monitor the voltage between the relays. In addition, when a difference between the battery voltage and the charge voltage of the capacitor is small, due to detection errors, etc., there is a possibility of erroneously distinguishing between normal state and the abnormal state due to being stuck in the ON state or in the OFF state. Therefore, it is difficult to detect the abnormality in reverse connection protection relay.

An object of the present disclosure is to provide a power supply device that appropriately performs an initial check of a reverse connection protection relay in a configuration that does not include a power supply relay.

A power supply device of the present disclosure includes a power converter, an input capacitor, a booster circuit, a precharge circuit, and a reverse connection protection relay. The power converter includes one or more sets of switching elements in upper and lower arms connected in series between a power supply line connected to the battery and a ground line, and converts a DC power of the battery and supplies the converted power to a load.

The input capacitor is connected in parallel to a battery on the battery side of the power converter. The booster circuit boosts the input voltage supplied from the battery to a target voltage. The precharge circuit applies the boosted voltage output by the booster circuit to the electrode on the high potential side of the input capacitor and precharges it.

The reverse connection protection relay is provided in a power supply line between the battery and the input capacitor and is parallel connected with a diode that allows current flow from the battery side to the power converter side, and interrupts the current flow from the power converter side to the battery side when the reverse connection protection relay is turned off. The power supply device does not include a power supply relay that interrupts the current flow from the battery side to the power converter side through the power supply line between the battery and the reverse-connection protection relay in an off state.

The power supply device includes a monitoring circuit configured to detect an abnormal due to being stuck in an ON state or in an OFF state of the reverse connection protection relay during an initial check of the power supply device.

At the time of an initial check, the booster circuit performs an overboost process in which a target voltage is temporarily raised above a value during normal operation. The precharge circuit applies the boosted voltage VS resulting from the overboost process to the electrode on the high potential side of the input capacitor. The monitoring circuit detects an abnormal due to being stuck in the ON state or due to being stuck in the OFF state of the reverse connection protection relay according to a post-relay voltage that is a voltage on the power converter side of the reverse connection protection relay.

In the overboost process, for example, a battery voltage of about 12 [V] is boosted to about 22 [V] and the input capacitor is precharged. When the reverse connection protection relay is in the abnormal state due to being stuck in the ON state, the boosted voltage applied when the reverse connection protection relay is turned off is not maintained, and a post-relay voltage becomes equivalent to the battery voltage.

When the reverse connection protection relay is in an abnormal state due to being stuck in the OFF state, the post-relay voltage does not drop when the reverse connection protection relay is turned on. By setting the target voltage for the overboost process by the booster circuit to be sufficiently higher than the battery voltage, it is possible to correctly discriminate between the voltages in a normal state and in a abnormal state due to being stuck. Therefore, the initial check of the reverse connection protection relay can be appropriately performed.

A power supply device according to an embodiment will be described based on the drawings. The power supply device according to the present embodiment converts a DC power of a battery and then supplies the converted power to a steering assistive motor as a load in an electric power steering device. The steering assistive motor includes a three-phase brushless motor.

Specifically, the ECU of the electric power steering device functions as the power supply device. The ECU includes, for example, a microcomputer, a pre-driver, and the like, and has a CPU, a ROM, a RAM, an I/O, and a bus line (not shown) connecting these components. The ECU performs required control by executing software processing or hardware processing. The software processing may be implemented by causing the CPU to execute a program. The program may be stored beforehand in a memory device such as a ROM, that is, in a readable non-transitory tangible storage medium. The hardware processing may be implemented by a special purpose electronic circuit.

The ECU of the electric power steering device starts up (that is, starts driving) when an ignition signal of the vehicle is turned to an ON state, and stops driving when the ignition signal is turned to an OFF state. Hereinafter, an operation during the initial check will be referred to as a normal operation. In the present embodiment, a configuration of the motor control during the normal operation performed by a control unit (not shown) is similar to that of a general motor control device. In the present embodiment, particular attention is paid to the initial check when the ECU is started.

### One Embodiment

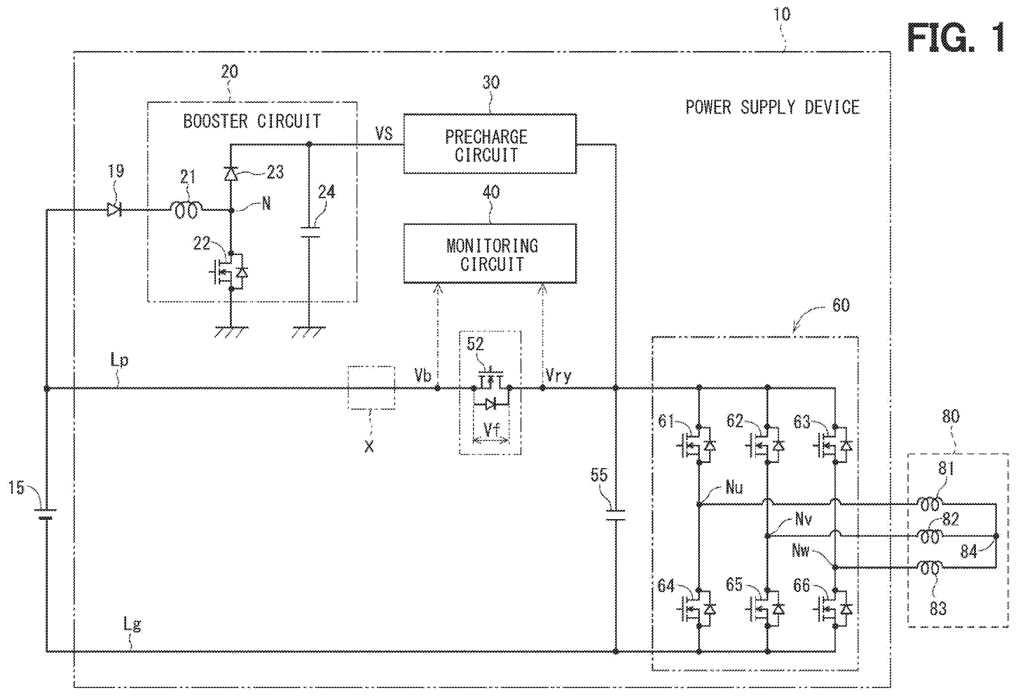

FIG. 1 shows the circuit configuration of a first embodiment. Although a circuit configuration of one system is illustrated, the present disclosure may be applied to the configuration of a redundant two system. A power supply device 10 supplies three-phase alternating current (AC) power generated by an inverter 60 to three-phase windings 81, 82, 83 of a motor 80. The inverter 60 corresponds to a power converter. For example, when the motor 80 is in a Y-connection, the three-phase windings 81, 82, 83 are connected at a neutral point 84. However, the three-phase windings 81, 82, and 83 may also be in delta connection.

The power supply device 10 includes the inverter 60, an input capacitor 55, a reverse connection protection relay 52, a booster circuit 20, a precharge circuit 30, a monitoring circuit 40, and the like. The inverter 60 is connected to a positive electrode of the battery 15 through a power supply line Lp, and is connected to a negative electrode of the battery 15 through a ground line Lg. The inverter 60 includes three sets of upper and lower arm switching elements 61 to 66, which are connected in series between the power supply line Lp and the ground line Lg.

The upper arm switching elements 61, 62, and 63 of the U phase, V phase, and W phase and the lower arm switching elements 64, 65, and 66 of the U phase, V phase, and W phase are connected in a bridge configuration. The inverter 60 converts the DC power of the battery 15 and supplies it to the three-phase windings 81, 82, and 83 of the motor 80 by each of the switching elements 61 to 66 performing a switching operation in response to a gate signal commanded by the control unit.

In the present embodiment, MOSFETs are used as the switching elements 61 to 66 of the inverters 60. In each of the switching elements 61 to 66, a free-wheeling diode that allows a current from the low potential side to the high potential side is configured as a parasitic diode inside the switching element. The connection points between the arms Nu, Nv, and Nw, which are connection points of the switching elements of the upper and lower arms of each phase, are connected to three-phase windings 81, 82, and 83 of the motor 80. A motor relay may be provided in the current path of each phase.

The input capacitor 55 is connected in parallel to the battery 15 on the battery 15 side of the inverter 60. During the normal operation, the input capacitor 55 smooths the input voltage supplied from the battery 15 and suppresses the switching noise of the inverter 60 from being transmitted to the outside. An electrode on the high potential side of the input capacitor 55 is connected to the precharge circuit 30.

A reverse connection protection relay 52 is provided on a power line Lp between the battery 15 and the input capacitor 55. In the reverse connection protection relay 52, a freewheeling diode for conducting a current from the battery 15 side to the inverter 60 side is connected in parallel. In the present embodiment, the parasitic diode of the MOSFET included in the reverse connection protection relay 52 conducts a current from the battery 15 side to the inverter 60 side. The reverse connection protection relay 52 cuts off a current from the inverter 60 side to the battery side when the reverse connection protection relay 52 is in the OFF state. The voltage drop due to the parasitic diode is written as Vf.

The reverse connection protection relay 52 corresponds to the second FET 32 disclosed in FIG. 1 of Patent Document 1 (Japanese Patent No. 5311233). By the way, in FIG. 1 of Patent Document 1, a first FET 31, which is a “power supply relay”, is provided in the power line between the battery and the reverse connection protection relay. The power supply relay is connected so that the orientation of the parasitic diode is opposite to the orientation of the reverse-connection protection relay, and cuts off a current from the battery side to the inverter side when the power supply relay is in the OFF state.

In contrast, the power supply device 10 according to the present embodiment does not include a power supply relay at a position indicated by a two-dot chain line. Accordingly, it is possible to reduce the number of parts of the power supply relay. Even during system stop in which the power supply device 10 stops driving, the battery voltage is applied to the input capacitor 55 so that the charging voltage is stabilized. On the other hands, the drawback of not having the power supply relay will be described hereinafter.

Next, the booster circuit 20 boosts the input voltage supplied from the battery to a target voltage. The booster circuit 20 is a chopper-type booster circuit including a reactor 21, a booster switching element 22, a diode 23, and a booster capacitor 24. The booster switching element 22 is composed of an N-channel MOSFET.

The reactor 21 has one end being connected to the positive electrode of the battery 15 via the diode 19, and a voltage obtained by subtracting the voltage drop across the diode 19 from the battery voltage (for example, about 12 [V]) is applied to the reactor 21 as an input voltage. The booster switching element 22 is connected between the other end of the reactor 21 and the ground. The diode 23 has an anode connected to a connection point N between the reactor 21 and the booster switching element 22. The booster capacitor 24 has a high potential side electrode connected to the cathode of the diode 23, and is charged with a boosted voltage.

The booster circuit 20 boosts the input voltage by repeating the accumulation and release of the induced energy of the reactor 21 by the PWM operation of the booster switching element 22, and outputs the output voltage. The booster switching element 22 is feedback-controlled so that the output boosted voltage VS matches the target voltage.

The precharge circuit 30 applies the boosted voltage VS output by the booster circuit 20 to the electrode on the high potential side of the input capacitor 55 and precharges it. In addition to the precharge circuit 30, the boosted voltage VS is outputted via a charge pump to driver circuits such as the reverse connection protection relay 52, the upper arm switching elements 61 to 63 of the inverter 60, and the motor relay. Further, the boosted voltage VS is output to the driver circuit of the lower arm switching elements 64 to 66 of the inverter 60 without passing through the charge pump. Each driver circuit outputs a gate signal to each switching element using the boosted voltage VS.

The monitoring circuit 40 detects the abnormal state due to being stuck in the ON state or in the OFF state of the reverse connection protection relay 52 during an initial check of the power supply device 10. Here, the voltage on the battery 15 side of the reverse connection protection relay 52 is defined as “battery voltage Vb”, and the voltage on the inverter 60 side of the reverse connection protection relay 52 is defined as “post-relay voltage Vry”. At the time of the initial check, the voltage applied from the precharge circuit 30 to the electrode on the high potential side of the input capacitor 55 becomes the post-relay voltage Vry.

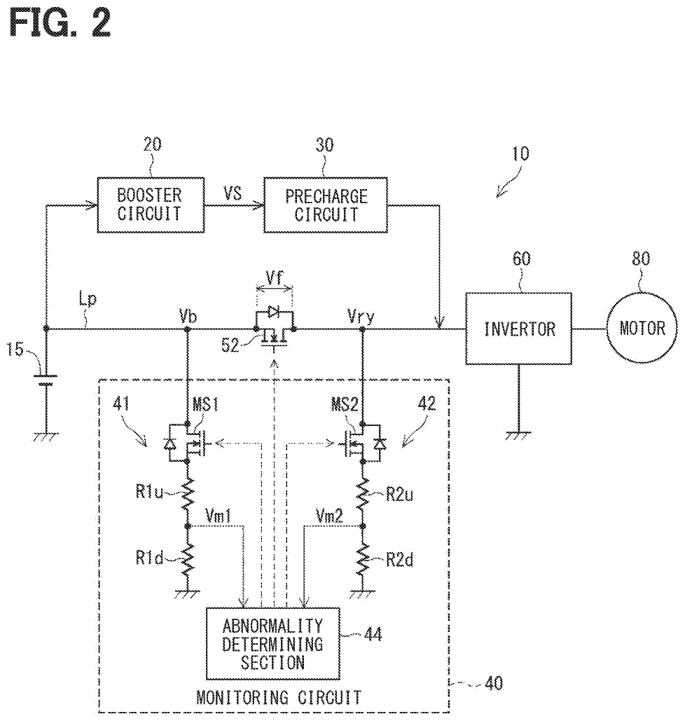

FIG. 2 shows a detailed configuration of the monitoring circuit 40. In FIG. 2, parts other than the monitoring circuit 40 and the reverse connection protection relay 52 are shown in simplified blocks compared to FIG. 1. Further, the configuration of the monitoring circuit 40 in FIG. 2 corresponds to a “Detection Method 2” described later, and monitors both the battery voltage Vb and the post-relay voltage Vry. On the other hand, when a “Detection method 1” is adopted, the monitoring circuit 40 may monitor only the post-relay voltage Vry without monitoring the battery voltage Vb.

The monitoring circuit 40 includes a first monitoring section 41 that monitors the battery voltage Vb, a second monitoring section 42 that monitors the post-relay voltage Vry, and an abnormality determining section 44. In the first monitoring section 41, a monitoring switch MS1 and upper and lower voltage dividing resistors R1u and R1d are connected in series between the battery 15 side of the reverse connection protection relay 52 and the ground. In the second monitoring section 42, a monitoring switch MS2 and upper and lower voltage dividing resistors R2u and R2d are connected in series between the inverter 60 side of the reverse connection protection relay 52 and the ground. The monitoring switches MS1 and MS2 are composed of, for example, MOSFETs. By turning off the monitoring switches MS1 and MS2 except when detecting voltage, current is prevented from flowing to the ground via the voltage dividing resistors R1u, R1d, R2u, and R2d.

When the monitoring switch MS1 of the first monitoring section 41 is turned on, the abnormality determining section 44 acquires a first monitor voltage Vm1 at the connection point between the voltage dividing resistors R1u and R1d. When the monitoring switch MS2 of the second monitoring section 42 is turned on, the abnormality determining section 44 acquires a second monitor voltage Vm2 at the connection point between the voltage dividing resistors R2u and R2d. As shown in the formula below, the first monitor voltage Vm1 and the second monitor voltage Vm2 reflect the battery voltage Vb and the post-relay voltage Vry, respectively.

Vm1=Vb×R1d/(R1u+R1d)

Vm2=Vry×R2d/(R2u+R2d)

The abnormality determining section 44 detects the abnormal state due to being stuck of the reverse connection protection relay 52 using a detection method described later, based on the battery voltage Vb and the post-relay voltage Vry obtained by converting the first monitor voltage Vm1 and the second monitor voltage Vm2. When the Detection Method 2 is used, the monitoring circuit 40 monitors the battery voltage Vb and the post-relay voltage Vry with the same configuration. This makes it possible to suppress variations. Furthermore, at least some of the elements constituting the monitoring circuit 40 may be provided inside an ASIC (ie, a customized IC). This reduces the board mounting area and the number of mounting steps.

By the way, in the initial check of Patent Document 1, a failure of the power supply relay and the reverse connection protection relay is detected based on the voltage at a point P1 between the power supply relay (first FET 31) and the reverse connection protection relay (second FET 32). However, since there is no power relay in the present embodiment, the voltage between the relays cannot be monitored. In addition, when a difference between the battery voltage Vb and the post-relay voltage Vry is small, due to detection errors, etc., there is a possibility of erroneously distinguishing between normal state and the abnormal state due to being stuck in the ON state or in the OFF state. Therefore, it is difficult to detect the abnormality in reverse connection protection relay 52.

Therefore, in the present embodiment, the following processes are performed at the time of initial check. The boost circuit 20 performs an “overboost process” in which the target voltage is temporarily raised above the value during normal operation. For example, an input voltage of about 12 [V] is boosted to about 16 [V] during normal operation, whereas it is boosted to about 22 [V] in the overboost process.

The precharge circuit 30 applies the boosted voltage VS resulting from the overboost process to the electrode on the high potential side of the input capacitor 55. Therefore, the boosted voltage VS due to the overboost process is applied to the inverter 60 side of the reverse connection protection relay 52. In this state, the monitoring circuit 40 detects the abnormal state due to being stuck in the ON state or in the OFF state of the reverse connection protection relay 52 according to the post-relay voltage Vry.

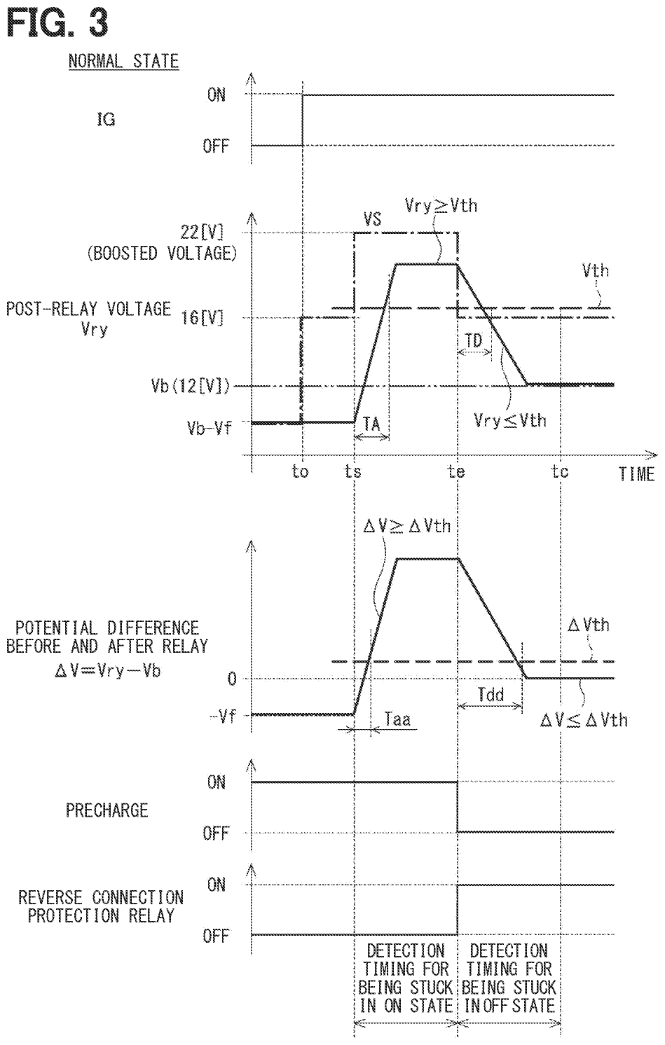

Next, with reference to FIGS. 3 to 5, a method for detecting the abnormal state due to being stuck of the reverse connection protection relay 52 in the initial check will be described in detail. Each figure shows, in order from the top, ON/OFF of the ignition switch (“IG” in the figure), the boosted voltage VS and the post-relay voltage Vry, a potential difference ΔV before and after the relay, ON/OFF of precharge, and ON/OFF of the reverse connection protection relay 52. The potential difference ΔV before and after the relay is defined as the potential difference (ΔV=Vry−Vb) obtained by subtracting the battery voltage Vb from the post-relay voltage Vry, and corresponds to the potential difference across the reverse connection protection relay 52.

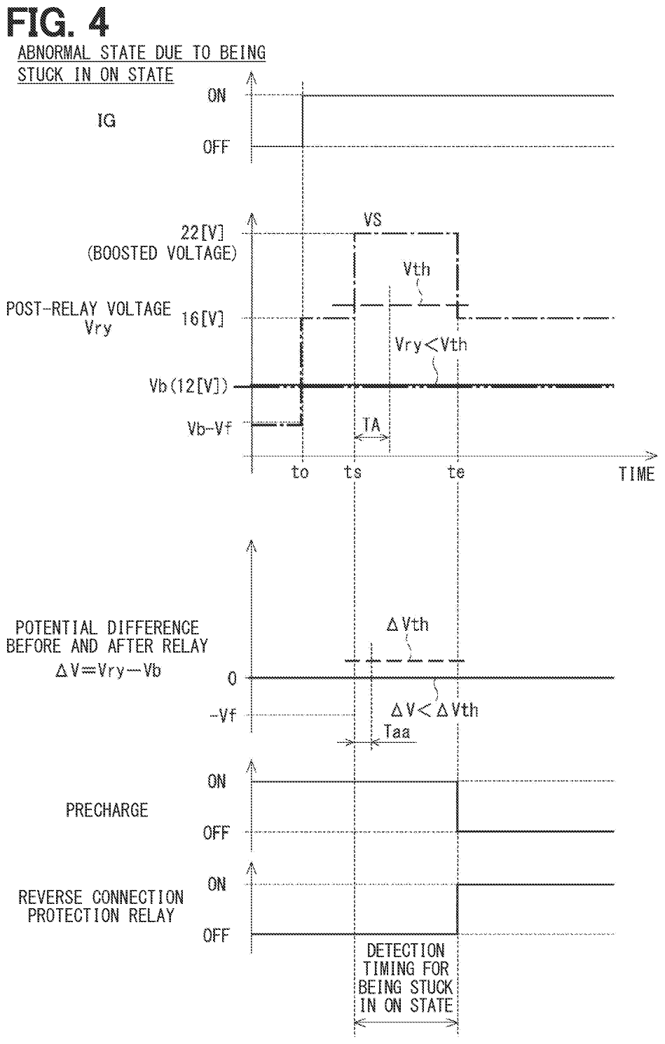

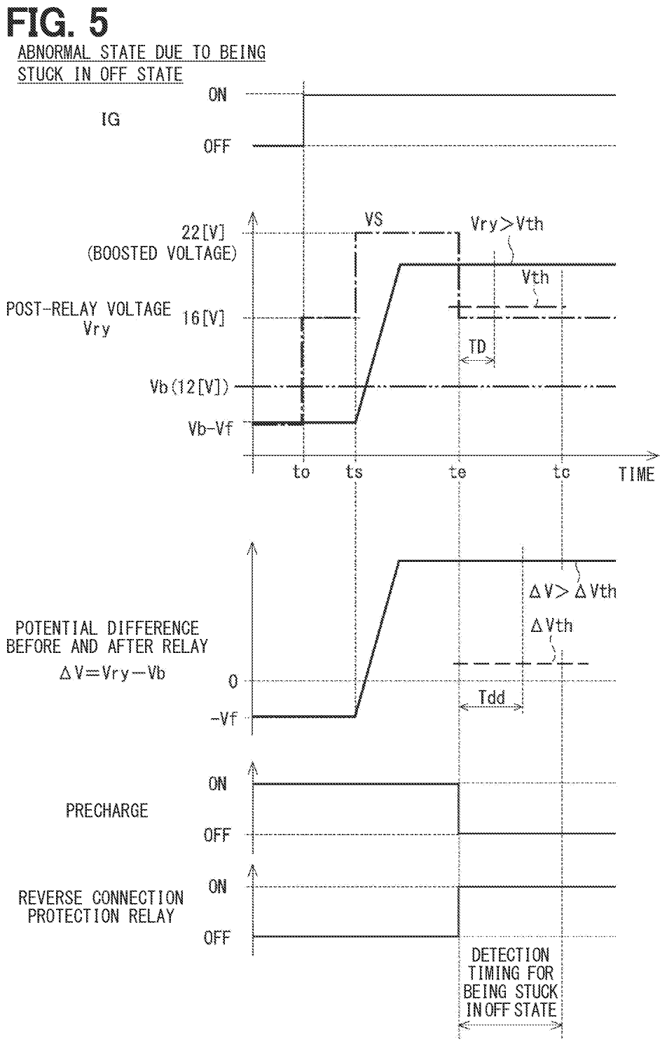

In FIGS. 3 to 5, items other than the post-relay voltage Vry and the potential difference ΔV before and after the relay are common. FIG. 3 shows the behavior of the post-relay voltage Vry and the voltage difference ΔV before and after the relay when the reverse connection protection relay is in the normal state, FIG. 4 shows the behavior when the reverse connection protection relay is in the abnormal state due to being stuck in the ON state, and FIG. 5 shows the behavior when the reverse connection protection relay is in the abnormal state due to being stuck in the OFF state. Before starting the power supply device 10, the ignition switch is OFF, the precharge by the precharge circuit 30 is ON, and the reverse connection protection relay 52 is OFF.

First, the boosted voltage VS, which is indicated by a two-dot chain line in each figure, will be explained. Here, it is assumed that the battery voltage is 12 [V], the boosted voltage VS during normal operation is 16 [V], and the boosted voltage VS due to the overboost process is 22 [V]. When the ignition switch is turned on at time to, the boosted voltage VS increases from 12 [V] to 16 [V]. Thereafter, from time ts to time te, the booster circuit 20 performs the overboost process, and the boosted voltage VS temporarily increases to 22 [V]. When the overboost process ends at time te, the boosted voltage VS returns to 16 [V] during normal operation.

At time te, the booster circuit 20 finishes the overboost process, and at the same time, the precharge to the input capacitor 55 by the precharge circuit 30 is turned off. Further, at time te, the reverse connection protection relay 52 is turned on from the OFF state. The period from time ts to time te is a detection timing for being stuck in the ON state. The period from time te to time tc is a detection timing for being stuck in the OFF state.

In the normal state shown in FIG. 3, the reverse connection protection relay 52 is OFF before time ts, and the current from the battery 15 side to the inverter 60 flows only through the parasitic diode. The post-relay voltage Vry is a value (Vb−Vf) obtained by subtracting the voltage drop Vf of the parasitic diode from the battery voltage Vb. At this time, the potential difference ΔV before and after the relay becomes a value (−Vf) obtained by subtracting a voltage drop Vf of the parasitic diode from 0 [V].

After time ts, in the normal state, the post-relay voltage Vry follows the increase in the boosted voltage VS with a delay, and finally increases to the maximum voltage (≈VS−Vf). Accordingly, the potential difference ΔV before and after the relay increases beyond 0 [V] to the maximum positive value. However, as shown in FIG. 4, when the reverse connection protection relay 52 is in the abnormal state due to being stuck in the ON state, the post-relay voltage Vry is not maintained and always remains at a value equivalent to the battery voltage Vb. Further, the potential difference ΔV before and after the relay is always 0 [V].

When the precharge is turned off at time te, in the normal state, the post-relay voltage Vry decreases due to discharge of the input capacitor 55. Further, since the reverse connection protection relay 52 is turned on, the post-relay voltage Vry gradually converges toward the battery voltage Vb. Accordingly, the potential difference ΔV before and after the relay decreases toward 0 [V]. However, as shown in FIG. 5, when the reverse connection protection relay 52 is in the abnormal state due to being stuck in the OFF state, the post-relay voltage Vry does not decrease from the maximum voltage due to the overboost process. Furthermore, the potential difference ΔV before and after the relay does not decrease from the maximum value.

Based on the above behavior, the monitoring circuit 40 can implement two methods for detecting the abnormal state due to being stuck, namely, the Detection method 1 based on the post-relay voltage Vry, and the Detection method 2 based on the potential difference ΔV before and after the relay.

### [Detection Method 1]

In the Detection method 1, the voltage threshold Vth is set to a value slightly higher (for example, about 18 [V]) than 16 [V], which is the boosted voltage VS during normal operation. Then, when the reverse connection protection relay 52 is in the normal state, a predetermined boost time TA is set based on the time for the post-relay voltage Vry to rise to the voltage threshold Vth after time ts. Further, after time te, a predetermined step-down time TD is set based on the time for the post-relay voltage Vry to drop to the voltage threshold Vth. Detection errors and variations are taken into consideration when setting the voltage boost time TA and the voltage drop time TD.

At the detection timing for being stuck in the ON state, as shown in FIG. 3, when the post-relay voltage Vry after the boost time TA has elapsed from time ts is equal to or higher than the voltage threshold Vth, it is determined that the reverse connection protection relay 52 is in the normal state. As shown in FIG. 4, when the post-relay voltage Vry after the boost time TA has elapsed from time ts is smaller than the voltage threshold Vth, it is determined that the reverse connection protection relay 52 is in the abnormal state due to being stuck in the ON state.

At the detection timing for being stuck in the OFF state, as shown in FIG. 3, when the post-relay voltage Vry after the drop time TD has elapsed from time te is equal to or less than the voltage threshold Vth, it is determined that the reverse connection protection relay 52 is in the normal state. As shown in FIG. 5, when the post-relay voltage Vry after the drop time TD has elapsed from time te is greater than the voltage threshold Vth, it is determined that the reverse connection protection relay 52 is in the abnormal state due to being stuck in the OFF state.

In this way, in the Detection method 1, the monitoring circuit 40 detects the abnormal due to being stuck in the ON state of the reverse connection protection relay 52 based on the post-relay voltage Vry after a predetermined boost time TA has elapsed from the time ts when the application of the boosted voltage VS was started due to the overboost process with the reverse connection protection relay 52 turned OFF. Further, the monitoring circuit 40 then turns on the reverse connection protection relay 52 and detects the abnormal due to being stuck in the OFF state of the reverse connection protection relay 52 based on the post-relay voltage Vry after a predetermined drop time TD has elapsed from the time te when the application of the boosted voltage VS due to the overboost process has ended.

### [Detection Method 2]

In the Detection method 2, the potential difference threshold value ΔVth is set to a value slightly larger than 0 [V] indicating that both ends of the reverse connection protection relay 52 are at the same potential. Then, when the reverse connection protection relay 52 is normal, a predetermined potential difference expansion time Taa is set based on the time for the potential difference ΔV before and after the relay to expand to the potential difference threshold value ΔVth after time ts. Further, after time te, a predetermined potential difference reduction time Tdd is set based on the time for the potential difference ΔV before and after the relay to reduce to the potential difference threshold value ΔVth. When setting the potential difference expansion time Taa and the potential difference reduction time Tdd, detection errors and variations are taken into consideration.

At the detection timing for being stuck in the ON state, as shown in FIG. 3, when the potential difference ΔV after the potential difference expansion time Taa has elapsed from time ts is equal to or higher than the potential difference threshold ΔVth, it is determined that the reverse connection protection relay 52 is in the normal state. As shown in FIG. 4, when the potential difference ΔV after the potential difference expansion time Taa has elapsed from time ts is less than the potential difference threshold ΔVth, it is determined that the reverse connection protection relay 52 is in the abnormal state due to being stuck in the ON state.

At the detection timing for being stuck in the OFF state, as shown in FIG. 3, when the potential difference ΔV before and after the relay after the potential difference reduction time Tdd has elapsed from time te is equal to or less than the potential difference threshold ΔVth, it is determined that the reverse connection protection relay 52 is in the normal state. As shown in FIG. 5, when the potential difference ΔV before and after the relay after the potential difference reduction time Tdd has elapsed from time te is greater than the potential difference threshold ΔVth, it is determined that the reverse connection protection relay 52 is in the abnormal state due to being stuck in the OFF state.

In this way, in the Detection method 2, the monitoring circuit 40 detects the abnormal due to being stuck in the ON state of the reverse connection protection relay 52 based on the potential difference ΔV before and after the relay after a predetermined potential difference expansion time Taa has elapsed from the time ts when the application of the boosted voltage VS was started due to the overboost process with the reverse connection protection relay 52 turned OFF. Further, the monitoring circuit 40 then turns on the reverse connection protection relay 52 and detects the abnormal due to being stuck in the OFF state of the reverse connection protection relay 52 based on the potential difference ΔV before and after the relay after a predetermined potential difference reduction time Tdd has elapsed from the time te when the application of the boosted voltage VS due to the overboost process has ended.

In the Detection method 1, it takes time for the post-relay voltage Vry to rise to the voltage threshold Vth in detecting the abnormal due to being stuck in the ON state. Particularly when the battery voltage Vb is low, charging takes time and abnormality detection is delayed. On the other hand, in the Detection method 2, when the application of boosted voltage VS by the overboost process is started, the potential difference ΔV before and after the relay immediately reaches the potential difference threshold ΔVth in the normal state, regardless of the battery voltage Vb. In other words, the potential difference expansion time Taa of the Detection method 2 can be set shorter than the boost time TA of the Detection method 1. It is possible to detect the abnormal due to being stuck in the ON state quickly.

### (Overview)

As described above, in the present embodiment, by setting the target voltage for the overboost process by the booster circuit 20 to be sufficiently higher than the battery voltage Vb, it is possible to correctly discriminate between the voltages in a normal state and in a abnormal state due to being stuck. Therefore, the initial check of the reverse connection protection relay 52 can be appropriately performed.

### Other Embodiments

(a) The load of the power supply device 10 is not only limited to a three-phase motor 80, but may also be a single-phase motor or a multi-phase motor other than the three-phase motor. Additionally, the load may also be an actuator other than a motor or another load. The number of switching elements in the upper and lower arms of the inverter is not limited to three, but may be one or more. As the “power converter”, an H-bridge circuit or the like may be used instead of a polyphase inverter.

(b) The reverse connection protection relay 52 and other switching elements are not limited to MOSFETs, and may be configured with other types of transistors.

(c) As described in the description of the above embodiment, at least some of the elements constituting the monitoring circuit 40 may be provided inside the ASIC.

The present disclosure should not be limited to the embodiment described above. Various other embodiments may be implemented without departing from the scope of the present disclosure.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A power supply device, comprising:
a power converter including one or more sets of switching elements in upper and lower arms connected in series between a power supply line connected to a battery and a ground line, and being configured to convert a DC power of the battery and supply the converted power to a load;
an input capacitor connected in parallel to the battery on the battery side of the power converter;
a booster circuit configured to boost an input voltage supplied from the battery to a target voltage;
a precharge circuit configured to apply a boosted voltage outputted by the booster circuit to an electrode on a high potential side of the input capacitor and to precharge;
a reverse connection protection relay provided in the power supply line between the battery and the input capacitor and being parallel connected with a diode that allows current flow from the battery side to the power converter side, and configured to interrupt the current flow from the power converter side to the battery side when the reverse connection protection relay is turned off; and
a monitoring circuit configured to detect an abnormal state due to being stuck in an ON state or in an OFF state of the reverse connection protection relay during an initial check of the power supply device; wherein
a power supply relay configured to interrupt the current flow from the battery side to the power converter side through the power supply line between the battery and the reverse connection protection relay in an off state is not included, and
at a time of the initial check,
the boost circuit performs an overboost process in which the target voltage is temporarily raised above a value during normal operation,
the precharge circuit applies the boosted voltage resulting from the overboost process to the electrode on the high potential side of the input capacitor, and
the monitoring circuit detects an abnormal due to being stuck in the ON state or due to being stuck in the OFF state of the reverse connection protection relay according to a post-relay voltage that is a voltage on the power converter side of the reverse connection protection relay.

2. The power supply device according to claim 1, wherein
the monitoring circuit
detects the abnormal due to being stuck in the ON state of the reverse connection protection relay based on the post-relay voltage after a predetermined boost time has elapsed from a time when an application of the boosted voltage was started due to the overboost process with the reverse connection protection relay turned OFF, and
thereafter, turns on the reverse connection protection relay and detects the abnormal due to being stuck in the OFF state of the reverse connection protection relay based on the post-relay voltage after a predetermined drop time has elapsed from a time when the application of the boosted voltage due to the overboost process has ended.

3. The power supply device according to claim 1, wherein
a potential difference obtained by subtracting the voltage of the battery from the post-relay voltage is defined as a potential difference before and after the relay, and
the monitoring circuit
detects the abnormal due to being stuck in the ON state of the reverse connection protection relay based on the potential difference before and after the relay after a predetermined potential difference expansion time has elapsed from a time when an application of the boosted voltage was started due to the overboost process with the reverse connection protection relay turned OFF, and
thereafter, turns on the reverse connection protection relay, and detects the abnormal due to being stuck in the OFF state of the reverse connection protection relay based on the potential difference before and after the relay after a predetermined potential difference reduction time has elapsed from the time when the application of the boosted voltage due to the overboost process has ended.
